(19) United States
(12) Patent Application Publication
(10) Pub. No.: US 2022/0415538 A1
(43) Pub. Date: Dec. 29, 2022

(54) STRETCHABLE FIBER CONDUCTOR HAVING BUCKLED CONDUCTIVE POLYMER RIBBON WITHIN ELASTOMER TUBE

(71) Applicant: KING ABDULLAH UNIVERSITY OF SCIENCE AND TECHNOLOGY, Thuwal (SA)

(72) Inventors: Jian ZHOU, Davis, CA (US); Gilles LUBINEAU, Thuwal (SA)

(21) Appl. No.: 17/770,746

(22) PCT Filed: Oct. 7, 2020
(86) PCT No.: PCT/IB2020/059435

§ 371 Date: Apr. 21, 2022

Related U.S. Application Data
(60) Provisional application No. 62/960,818, filed on Jan. 14, 2020.
(60) Provisional application No. 62/926,608, filed on Oct. 28, 2019.

(51) Int. Cl. H01B 7/04; H01B 1/12; H01B 7/08

(52) U.S. Cl. CPC H01B 7/04; H01B 1/124; H01B 7/0869; H01B 3/442

(57) ABSTRACT

A stretchable electrically conductive coaxial fiber includes a tubular sheath that is made from a thermoplastic elastomer that is an electrical insulator, and an electrically conductive strip located inside the tubular sheath. The conductive strip is buckled inside the tubular sheath to form a ribbon.

### CROSS-REFERENCE TO RELATED APPLICATIONS

This application claims priority to U.S. Provisional Patent Application No. 62/926,608, filed on Oct. 28, 2019, entitled “A RESISTANCE-STABLE FIBER CONDUCTOR AT LARGE STRAINS,” and U.S. Provisional Patent Application No. 62/960,818, filed on Jan. 14, 2020, entitled “STRETCHABLE FIBER CONDUCTOR HAVING BUCKLED CONDUCTIVE POLYMER RIBBON WITHIN ELASTOMER TUBE,” the disclosures of which are incorporated herein by reference in their entirety.

### BACKGROUND

### Technical Field

Embodiments of the subject matter disclosed herein generally relate to a fiber conductor that can sustain large strains without exhibiting a substantial change in its resistance, and more particularly, to a highly-stretchable coaxial fiber conductor that includes a self-buckling conductive polymer ribbon inside a thermoplastic elastomer channel.

### Discussion of the Background

Stretchable conductors are important building blocks in many applications including wearable electronics, flexible displays, transistors, and energy devices. Such conductors need to meet the following requirements: (1) be capable of accommodating a high strain (much larger than 100% of its relaxes length); (2) have a stable (constant) electrical resistance when stretched; and (3) feature a reversible response, both mechanically (recoverable strain) and electrically (recoverable resistance if any change), when the mechanical loading that generates the strain is removed.

Fiber-like conductors display a wide range of geometries. Their tiny volume, high-flexibility and weavability make them particularly promising for the next generation of wearable electronic devices. Continuous fiber conductors can be divided into two categories, (1) piezoresistive based fibers, and (2) resistance-stable based fibers, depending on their electrical response to an applied mechanical strain. The resistance of the piezoresistive fibers varies significantly with the applied strain, making them good candidates for strain sensing. There are two main approaches for the fabrication of piezoresistive fiber conductors: one involves using a conductive filler/elastomer composite fiber, while the other approach involves using a conductive filler/elastomer coaxial fiber [1], [2]. For the piezoresistive fibers, the change in distance between the particles in a network of nanoparticles, the morphology, and the density of the networks are factors that affect their efficiency. However, the interface between the particles making up these fibers can be engineered to tailor the intensity of the piezo-resistivity to a desired value.

On the other hand, the resistance-stable fibers can operate under large tensile strains without any significant change in their electrical resistance. Some high performance technologies already exist for forming such fibers. One such technology uses a stretchable and conductive fiber created by injecting a liquid metal alloy into an hollow elastic fiber. The metallic core of the fiber can maintain a high conductivity for up to 600% stretch of the fiber. However, one major drawback of this technology is the risk that a fiber-breakage event causes the liquid metal to leak outside the fiber and release harmful substances into the environment.

Highly stretchable sheath-core conducting fibers have also been fabricated by wrapping carbon nanotube (CNT) sheets on stretched rubber fiber cores. This technique was shown to be efficient in creating fibers with a stretch-insensitive resistance. However, the fact that the exposed CNTs are aligned perpendicularly to the fiber direction result in a low conductivity of 3.6 S/cm, a value prohibitive for most electronic devices.

In another study, a dielectric layer was sandwiched between functionalized buckled CNT sheets in order to form twistable and stretchable electrodes. In this case, the relative change in resistance of the fiber was only 3.7% at 200% strain; however, the exposure of the CNT to the environment remains a concern for both the environment and the human safety.

These pioneering studies have made it possible to fabricate high-performance, resistance-stable, fiber conductors that can sustain large amounts of strain. Yet, the exposure or leakage of the conductive/hazardous materials into the environment constitute a major issue that has to be resolved before deploying them as practical stretchable fiber-conductors.

Thus, there is a need for a fiber that is stretchable, highly-conductive, and has a constant resistance when stretched and avoids the problems noted above.

### BRIEF SUMMARY OF THE INVENTION

According to an embodiment, there is a stretchable electrically conductive coaxial fiber that includes a tubular sheath that is made from a thermoplastic elastomer that is an electrical insulator, and an electrically conductive strip located inside the tubular sheath. The conductive strip is buckled inside the tubular sheath to form a ribbon.

According to another embodiment, there is a method for making a stretchable electrically conductive coaxial fiber. The method includes providing a conductive dispersion solution, providing a thermoplastic elastomer solution, wet-spinning the conductive dispersion solution and the thermoplastic elastomer solution to form a precursor coaxial fiber, which has a core including the conductive dispersion solution in a fluid state and has a tubular sheath including the thermoplastic elastomer solution in a solid state, bathing the precursor fiber into a bath to further solidify the tubular sheath while the core remains into the liquid phase, straining the precursor fiber with a given strain, drying the precursor fiber to solidify the core to form an electrically conductive strip, and removing the given strain so that the electrically conductive strip buckles inside the tubular sheath to form a ribbon.

According to still another embodiment, there is a flexible electrical cable that includes a stretchable electrically conductive coaxial fiber and first and second end caps attached to ends of the coaxial fiber and the first and second end caps are configured as electrical pads. The coaxial fiber includes a tubular sheath that is made from a thermoplastic elastomer that is an electrical insulator, and an electrically conductive strip located inside the tubular sheath, where the conductive strip is buckled inside the tubular sheath to form a ribbon.

### BRIEF DESCRIPTION OF THE DRAWINGS

Fora more complete understanding of the present invention, reference is now made to the following descriptions taken in conjunction with the accompanying drawings, in which:

FIG. 1 is a flowchart of a method for forming a stretchable electrically conductive coaxial fiber;

FIG. 2 illustrates a system for making a stretchable electrically conductive coaxial fiber;

FIGS. 3A to 3C illustrate the various stages of making the stretchable electrically conductive coaxial fiber;

FIGS. 4A to 4F illustrate a cross-section of the stretchable electrically conductive coaxial fiber after being pre-strained with different strains and FIG. 4G illustrates the buckling density for various strains;

FIGS. 5A to 5D illustrate computer tomography cross-sections of the stretchable electrically conductive coaxial fiber;

FIGS. 6A and 6C to 6F illustrate the strain independence of the electrical properties for the coaxial fiber, FIG. 6B illustrates the maximum failure strain versus different fabrication pre-strains of the coaxial fiber, and FIGS. 6G and 6H illustrate the relative change in the tensile stress vs strain for differently pre-strained coaxial fibers;

FIGS. 7A to 7D illustrate the long-term resistance-stability of the coaxial fiber over a large number of cycles;

FIG. 8A shows the tensile stress vs strain curve of PEDOT/PSS/PBP films with different PBP fractions during incremental cyclic loading/unloading, FIG. 8B illustrates the electrical conductivity of self-standing PEDOT/PSS/PBP fibers at different PBP fractions, and FIG. 8C illustrates Raman spectra of a pure PEDOT/PSS film and a PEDOT/PSS/PBP film with a PBP fraction; and

FIG. 9 illustrates an electrical wire that is made with the stretchable electrically conductive coaxial fiber.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a self-buckled conductive core encapsulated in a stretchable sheath, where the core is prepared with a blend of a conductive polymer (poly (3,4-ethylene-dioxythiophene)/polystyrene sulfonate (PEDOT/PSS)) and a copolymer (polyethylene-block-poly-(ethylene glycol) (PBP)) while the sheath includes a thermoplastic elastomer. However, the embodiments to be discussed next are not limited to these specific chemical compositions, and other conductive polymers for the core and thermoplastic elastomers for the sheath may be used.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a novel conductor fiber having a coaxial structure is manufactured and this novel fiber displays a stable electrical performance under extreme strains. This innovative structure, which includes a self-buckled conductive core fully encapsulated in a thermoplastic elastomer, was prepared with a blend of the conductive polymer PEDOT/PSS and the copolymer PBP for the core.

A method of making this fiber uses a coaxial wet-spinning assembly approach to continuously spin coaxial fibers made of a thermoplastic elastomer-wrapped PEDOT/PSS/PBP aqueous solution. Then, the method applies a “solution stretching-drying-buckling” approach to obtain the desired morphology of the conductive layer, which is made of conductive fibers with a self-buckled conductive core.

In various studies, the pre-strain approach has been applied to engineer the fiber's structure and showed promising results towards stretchable fiber conductors. For example, by pre-straining gold coated AuNWs/elastomeric fibers, reversible directional cracks along the axis are found. These cracks close again when the strains are back to the nominal configuration, which restores the conductivity up to 461 S cm⁻¹, when the strain is increased to 380%. In another study, highly-stretchable sheath-core conducting fibers were produced by wrapping CNT sheets oriented in the fiber direction on pre-strained rubber fiber cores. By releasing the pre-strain, sheath buckling of the CNT sheets was observed in the axial and belt directions, enabling a resistance-stable characteristics at extremely large strain 1,000%). However, the pre-straining approach used in the novel method is applied with a liquid conductive phase in the core of a coaxial fiber, which is different compared with the aforementioned two examples.

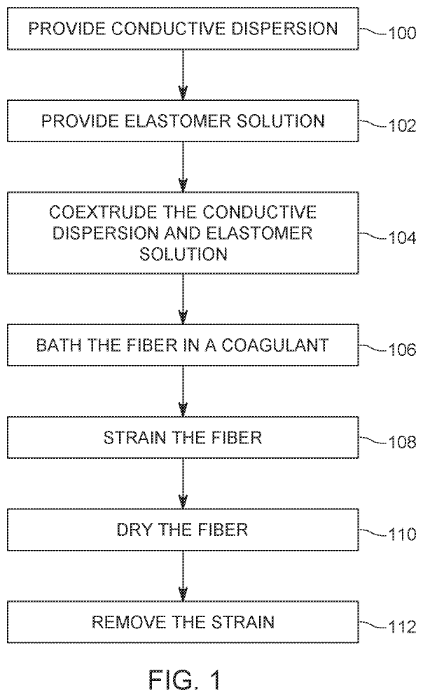

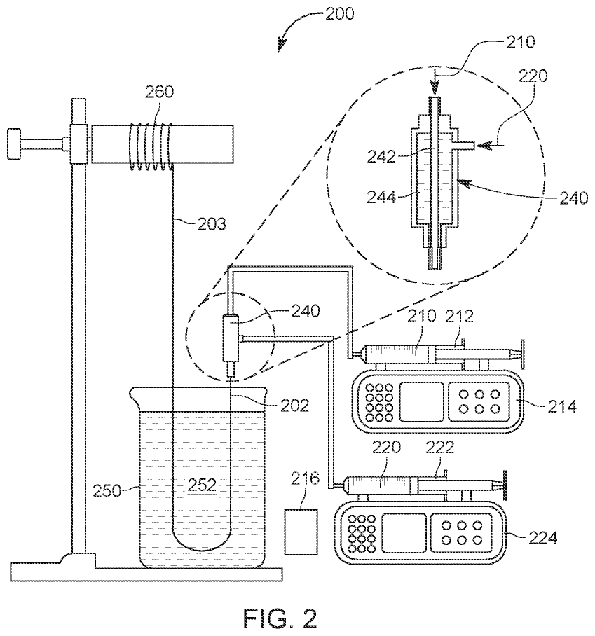

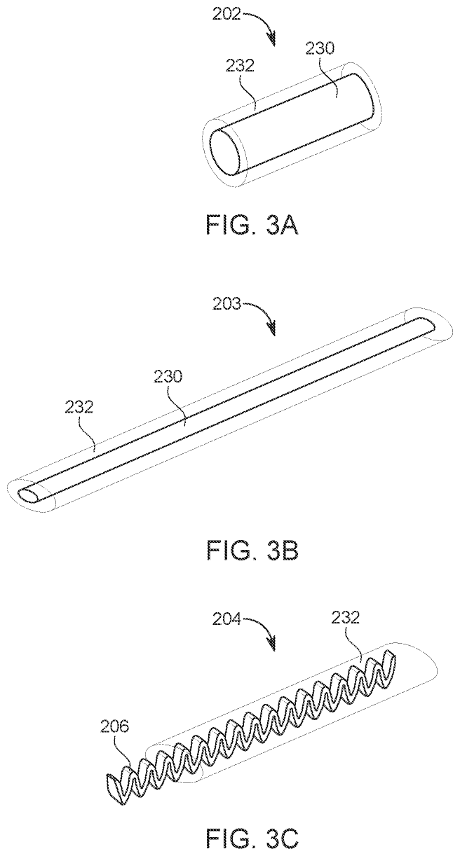

The method for forming this novel fiber is now discussed with regard to the flowchart of FIG. 1 and a system 200 for forming the fiber is shown in FIG. 2. In step 100, a conductive dispersion solution 210 (see FIG. 2) is provided. As discussed above, for simplicity, in this embodiment it is considered that the conductive dispersion solution 210 is the PEDOT/PSS-based aqueous dispersion that will form the core 230 of the precursor fiber 202, as illustrated in FIG. 3A. In one application, the conductive dispersion solution 210 is obtained by evaporating 10 mL of water from 20 mL of the PEDOT/PSS-based aqueous dispersion (11 mg mL⁻¹) at 50° C. to increase the viscosity of the solution. Different weight fractions (fₛ=0, 0.1, 0.2, 0.3, 0.4, 0.5, 0.6, 0.7) of PBP were mixed into the concentrated PEDOT/PSS-based aqueous dispersion (22 mg mL⁻¹), using a magnetic stirrer for two hours. However, those skilled in the art will know that other conductive solutions may be used as long as they are electrically conductive and highly stretchable.

FIG. 2 shows that the conductive dispersion solution 210 may be supplied from a supply device 212, for example, a syringe, and a flow rate of the solution 210 from the supply device 212 is controlled by a controller 214. The controller 214 may be in communication with a computing device 216 (for example, a computer) that is configured to control the release speed of the conductive dispersion solution 210.

In step 102, a thermoplastic solution 220 (see FIG. 2) is provided. As discussed above, for simplicity, in this embodiment it is considered that the thermoplastic solution 220 is the TPE dissolved in dichloromethane (DCM), and this solution will form the core sheath 232 of the precursor fiber 202, as illustrated in FIG. 3A. In one application, a 25 wt. % TPE solution was prepared by mixing TPE pellets with a CH₂Cl₂ solvent, at 200 rpm, for 10 hours. However, those skilled in the art will know that other thermoplastic elastomers may be used as long as they are electrically non-conductive and highly stretchable.

FIG. 2 shows that the TPE solution 220 may be supplied from a second supply device 222, for example, a syringe, and a flow rate of the solution 220 from the second supply device 222 is controlled by a controller 224. The controller 224 may be in communication with the computing device 216, which is configured to control the release speed of the conductive dispersion solution 220.

The first and second solutions 210 and 220 are supplied to a spinning nozzle 240, which is placed above a liquid bath container 250. The first and second solutions are wet-spun in step 104 (coaxial wet-spinning) through the spinning nozzle 240, with the first solution 210 forming the core 230 of the precursor fiber 202, and the second solution 220 forming the sheath 232. In one application, the flow rate of each of the first and second solutions was kept constant at 200 μl/min.

The spinning nozzle 240 consists of a coaxial inner channel 242 and an outer channel 244 constructed with 21 and 15 gauge (G) needles, respectively. The outer channel 244 is formed around the inner channel 242 so that the inner channel is fully enclosed by the outer channel. Those skilled in the art would understand that other diameter sized may be used for the inner and outer channels. The extruded precursor fiber 202 enters in step 106 into the liquid bath container 250, to experience a solution stretching-drying-buckling process, to produce a final coaxial fiber 204 having buckled conductive strips (or ribbons) 206 inside the TPE channel 232, as shown in FIG. 3C.

The precursor coaxial fiber 202 is wet-spun using the TPE solution 220 dissolved in DCM, to form the sheath 232, and using the PEDOT/PSS-based aqueous dispersion 210, to form the core 230. The solution for the core is obtained by adding polyethylene-block-poly(ethylene glycol) (PBP) to the PEDOT/PSS aqueous dispersion 230 to increase its electrical conductivity and stretchability. The obtained solution is named PEDOT/PSS/PBP herein. Note that in this embodiment no carbon fibers or carbon nanofibers are used to form the sheath or the core.

The bath container 250 holds in this embodiment an ethanol coagulation bath 252. The ethanol coagulation bath 252 extracts the DCM from the TPE solution 220, which makes the sheath 232 to transform from a liquid phase to a gel/solid phase as the precursor fiber 202 is submerged in the coagulation bath 252. The fast solidification of the TPE in the ethanol bath in step 106 ensures that the sheath 232 has a solid-like consistency when the half-formed fiber 203 (the fiber at this stage in the process is called “half-formed” because the core is not yet in its final phase) is exiting the bath container 250. This solid consistency is able to confine the core 230 within the sheath 232, while the core 230 still includes a large amount of water and is still in a liquid phase after the extrusion of the precursor fibers 202. The ethanol in the coagulation bath could be replaced by acetone, isopropyl alcohol or a mixture of ethanol and acetone (volume ratio is 1:1), a mixture of acetone and isopropyl alcohol (volume ratio is 1:1), or a mixture of ethanol and isopropyl alcohol (volume ration is 1:1).

In this regard, as the half-formed fiber 203 is exiting from the bath 252, the sheath 232 is solid and super-flexible, while the core 230 is liquid. Because the half-formed fiber 203 is extracted in a vertical manner as illustrated in FIG. 2 (note that the half-formed fiber 203 may be extracted in other configurations), on a rotating spool 260, the sheath 232 is strained in step 108, due to the gravity and/or the rotation of the spool 260, as illustrated in FIG. 3B. Note that the half-formed fiber 203 in FIG. 3B corresponds to the spun fiber 202 in FIG. 3A. In one application, the spool 260 was rotated with a linear speed of about 2 to 4 m per minute.

As the core 230's material is still fluid, this material is capable of extending as much as the sheath 232 is extending, forming a thin, continuous, long filament inside the channel formed by the sheath 232. Because of the straining step 108, the amount of water inside the channel formed by the sheath 232 is thinly spread and pores are opened in the sheath, which promote water evaporation. Although the pores in the sheath help with the drying process, these pores do not result in leakage of the conductive core, which is still in the liquid state at this stage. This has been confirmed by measuring the electrical conductivity on the surface of the as-spun fiber 202. These conditions, which are illustrated in FIG. 3B, permit the half-formed fiber 203 to dry in step 110, i.e., the water from the core is being evaporated. This step may take place in a fume hood, over a period of several days, for example, 3 days.

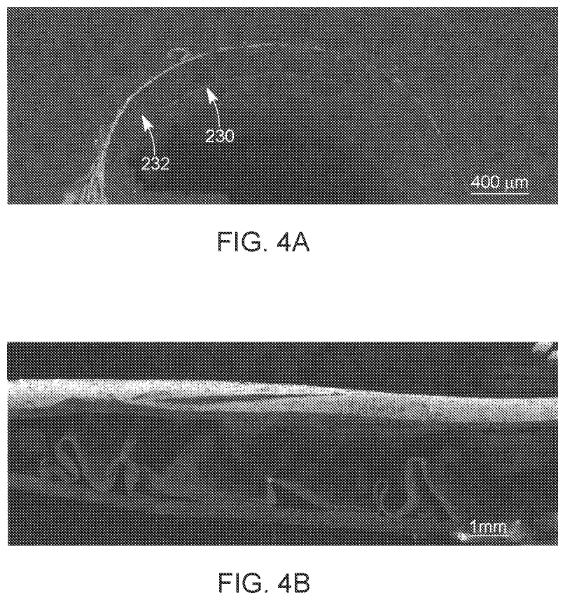

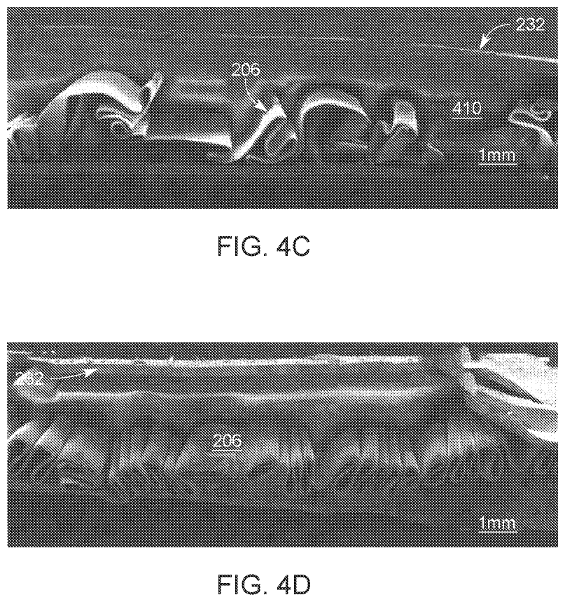

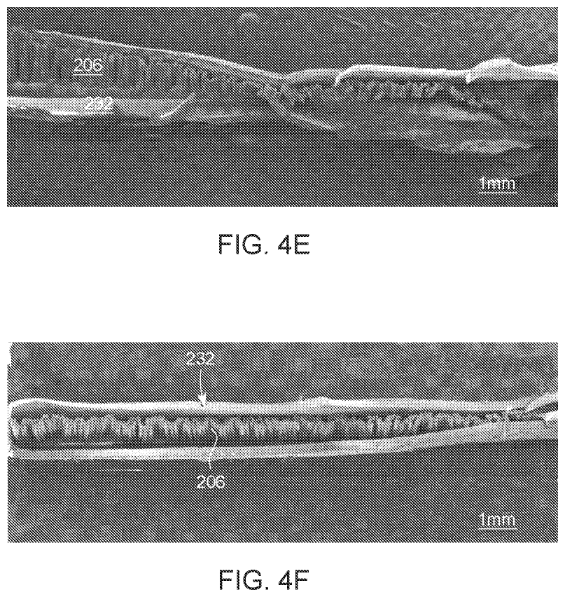

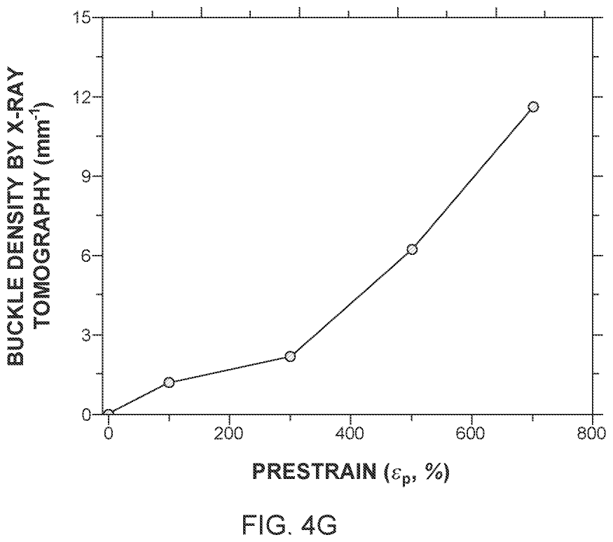

At the end of this step, the final fiber 204 is formed by removing the strain from the fiber in step 112, so that the sheath 232 de-stretches and takes its initial length, while the now solid core buckles forming a buckled conductive strip/ribbon 206, which fits into the shorter sheath, as illustrated in FIG. 3C. Various samples of the final fiber 204, which were relaxed from different pre-strain levels, were directly scanned using X-ray computed tomography (CT). The CT observations confirmed the three dimensional structure of the buckled PEDOT/PSS/PBP ribbons 206, as illustrated in FIGS. 4A to 4F. Note that the fiber 204 in FIG. 4A was not pre-strained, while the fibers in the remaining of the FIGS. 4B to 4F were strained to 100, 300, 500, 700, and 900%, respectively.

The buckle density of the ribbon 206 was measured from these figures and they were found to increase from 1.5 to 11.7 mm⁻¹, as the pre-strain increased from 100% to 700%, as illustrated in FIG. 4G. The buckle density is defined herein as being the number of turns that are counted along the ribbon 206 over a unit of length. For example, FIG. 4D shows that for a length of 1 mm along a longitudinal axis of the fiber, there are 15 buckles or turns of the strip 206. The buckling of the PEDOT/PSS/PBP strip 206 ensures the stability of the electrical resistance of the overall fiber, because upon stretching, the ribbon 206 progressively unfolds, which does not affect its electrical resistance. In one embodiment, there is a single ribbon 206 formed inside a given tubular sheath 232.

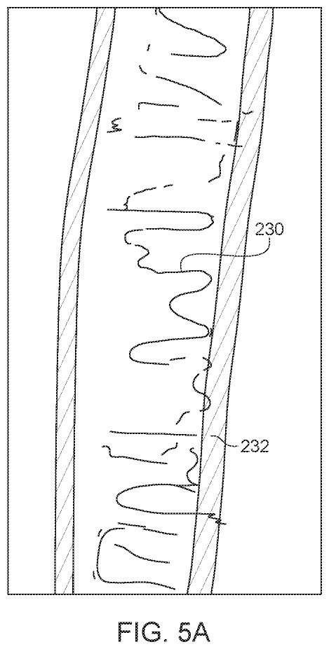

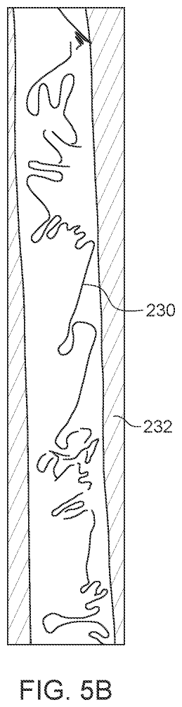

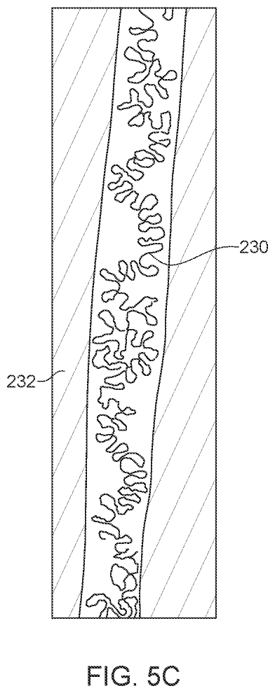

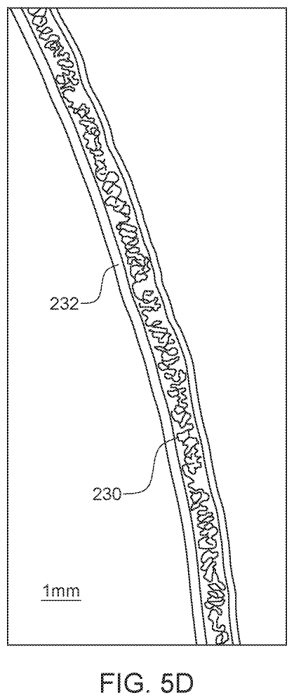

The coaxial fiber without pre-straining process, as illustrated in FIG. 4A, exhibited an average outer diameter of 780.4±28.0 μm and an average wall thickness of 68.7±7.2 μm. It was also found that the PEDOT/PSS/PBP core 230 was attached to the inner wall of the TPE sheath 232, with an average thickness of 24.5±3.8 μm. To reveal the microstructure of the fiber produced at different pre-strain levels, the TPE sheaths 232 were cut by blades to expose the core area. FIGS. 4B to 4F show the transformation of the conductive core's microstructure when relaxed from 100%, 300%, 500%, 700%, and 900% pre-strain. Most of the times, it was observed an uneven periodic buckling along the fiber axial direction and an increase in the buckling density as the level of pre-strain increased. These figures also show some empty spaces 410 (see FIG. 4C) between the conductive core and the sheath, which are consistent with the reconstructed computed tomography images of the fiber 204, in FIGS. 5A to 5D, for the 100, 300, 500, and 700% fabrication pre-strain, respectively.

These results prove that the adhesion between the hydrophilic PEDOT/PSS/PBP strip 206 and the hydrophobic TPE sheath 232 is very low, which is a prerequisite for the relaxation and buckling of the core 230 into the strip 206 when releasing the pre-strain. The inventors have also found that the width of the conductive core decreased as the pre-strain increased. This is consistent with optical microscopy and SEM measurements performed on each fiber.

At lower pre-strains (100%, 300% and 500%), only one scale of 1D buckles are observed, whereas at higher pre-strains (700% and 900%), hierarchical buckles along the fiber axial direction are observed, allowing even more extra strain to be stored in the conductive core.

To fully resolve the microstructure without damaging or modifying the fiber 204, the coaxial fiber specimens relaxed from different pre-strain levels were directly scanned using X-ray computed tomography (CT). The CT observations confirmed the three dimensional structure of the buckled PEDOT/PSS/PBP ribbons (see FIGS. 5A to 5D). The buckle density was measured from FIGS. 5A to 5D and was found to increase from 1.5 to 11.7 mm⁻¹, as the pre-strain increased from 100% to 700%. A buckling of the PEDOT/PSS/PBP ribbon 206 larger than 2 mm⁻¹ ensured the stability of the electrical resistance upon stretching, as the ribbon 206 got progressively unfolded during stretching.

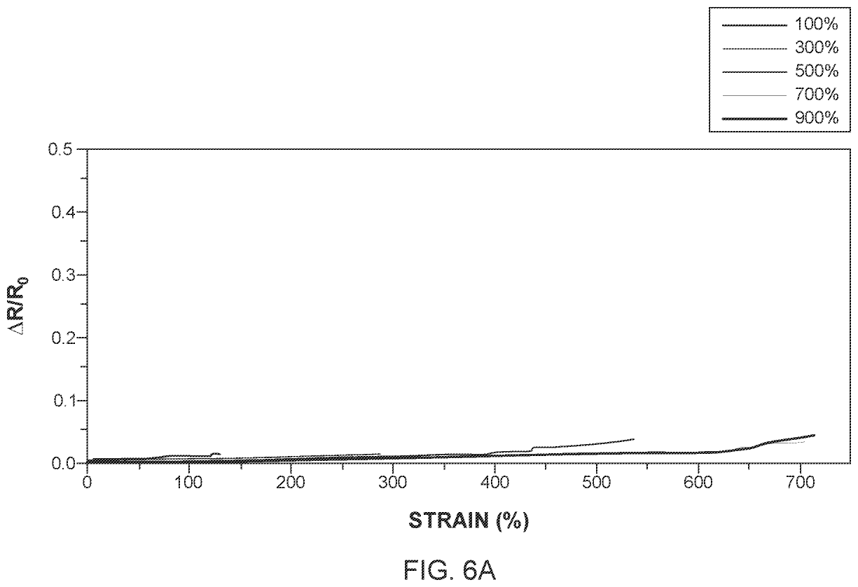

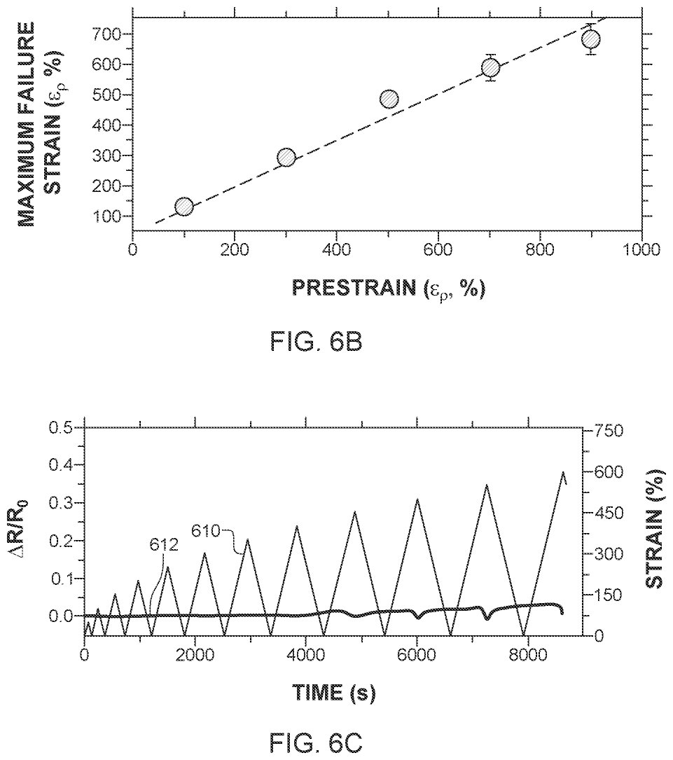

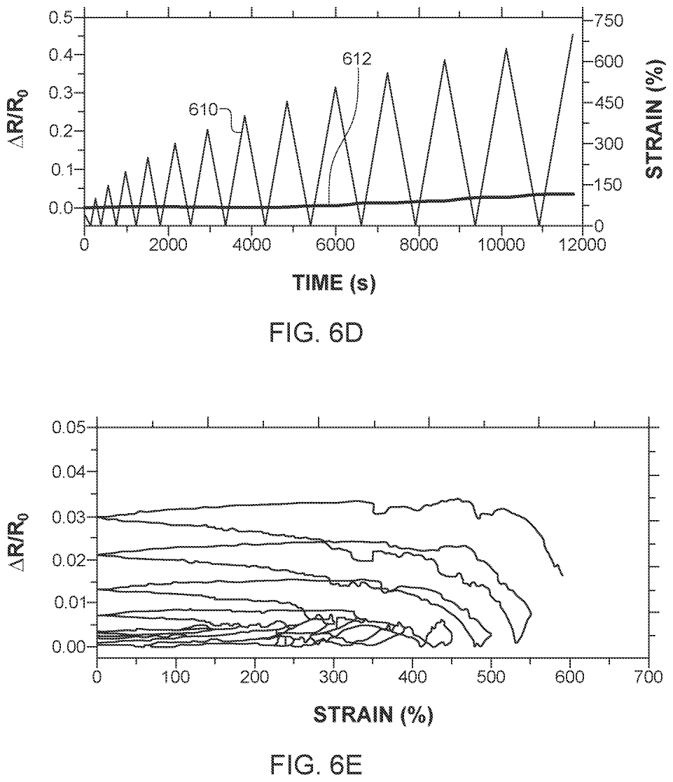

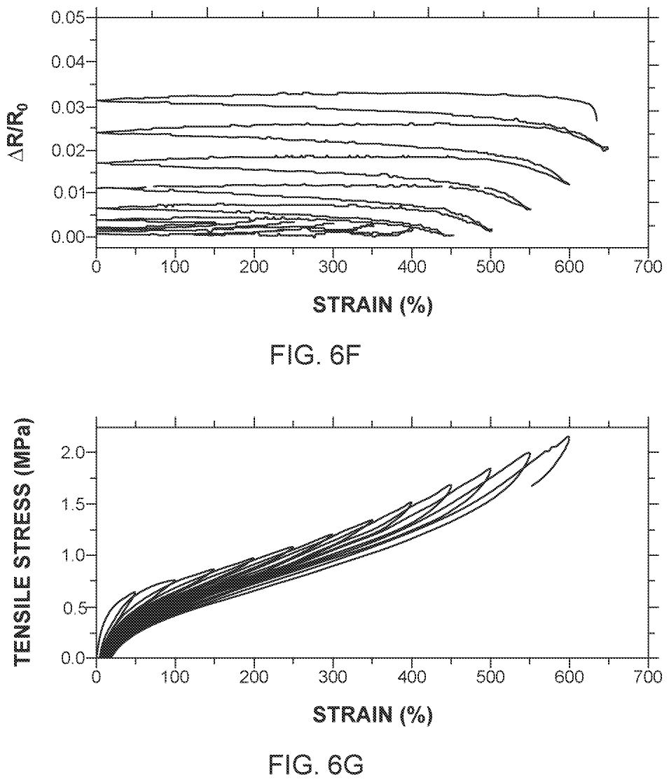

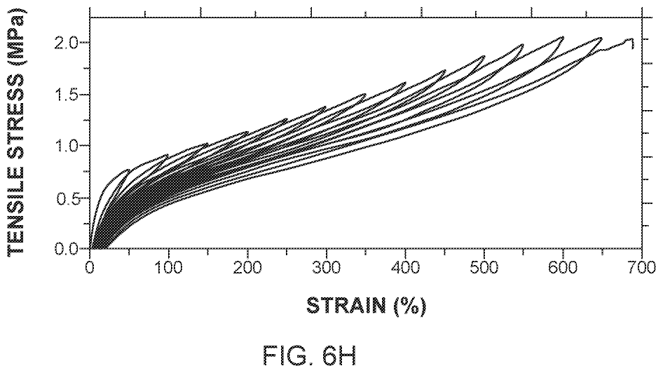

The electrical resistance stability (the term “stability” is used herein to describe a property of the electrical resistance of the fiber of not being affected by the stretching of the fiber) of the fabricated fibers 204 was also investigated. FIG. 6A illustrates the relative change in resistance, ΔR/R₀ of a coaxial fiber 204, when stretched up to its maximum failure strains εᵣ, where R₀ is the initial resistance, ΔR is the change in resistance at a certain strain. The maximum failure strains εᵣ is defined as the strain for which the conductive core breaks, which results in an infinite resistance. The fibers were prepared with pre-strain levels εₚ of 100, 300, 500, 700, 900%. The ΔR/R₀ for each sample at their maximum failure strain ε_{f} is very small. For example, when εₚ=900%, ΔR/R₀=0.04 at ε_{f}=713.0%. Repeating these tests on similar fibers, it was found that the fibers have an average maximum ΔR/R₀=0.032±0.016, with an average strain at failure of ε_{f}=675.8±51.7%. This confirms that during a monotonic loading, the coaxial fibers 204 display a very good resistance stability under a wide range of strains. Moreover, by increasing the εₚ applied to the samples from 100% to 900%, the ε_{f} is increased from 129.1±13.2% to 675.8.1±51.7%, as illustrated in FIG. 6B.

The performance of the novel fiber 204 was further investigated with regard to the degradation of the electrical and mechanical properties during repeated stretching/unstretching. As illustrated in FIGS. 6C and 6D, incremental cyclic loading/unloading tests were performed on the fiber 204 with εₚ=700% and 900%, respectively. Curve 610 illustrates the applied strain while curve 612 illustrates the measured change in resistance ΔR/R₀ for each case. The resistance stabilities at large strains for both samples were found to be consistent with the monotonic loading test. These fibers fully recovered after the strain was applied as the TPE sheath mainly deformed in an elastic manner. By plotting the change in resistance ΔR/R₀ over the applied strain, as illustrated in FIGS. 6E and 6F, it was found that the maximum ΔR/R₀ for the fiber with εₚ=700% and 900% were 0.035 and 0.031, respectively. FIGS. 6G and 6H show the incremental cyclic loading and unloading curves of the fiber with εₚ=700% and 900%, respectively. These curves show the typical mechanical behavior of pure TPE (i.e., its tensile stress versus strain), which could be highly stretched while remaining in the reversible domain. These coaxial fibers present mechanical failures at ε_{f}=555% and 690%, respectively. This can be ascribed to the crack-opening on the TPE sheath under large strains. All these graphs indicate the very good stability of the resistance of the novel fibers when experiencing extreme strain conditions, which is highly desirable for many electrical and electronic applications. Also, the scalability of the manufacturing process of these fibers and the low-cost associated with the components of these fibers make these novel fibers a very good candidate for practical applications.

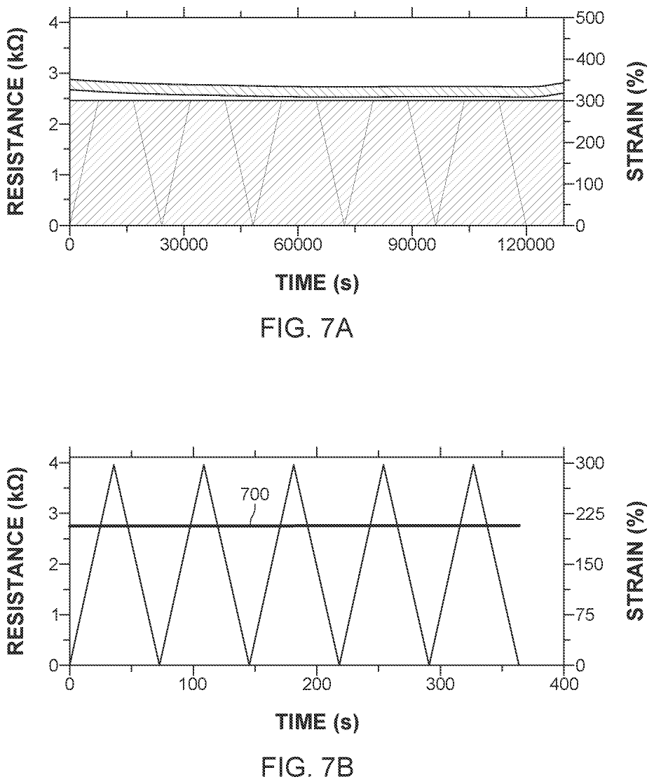

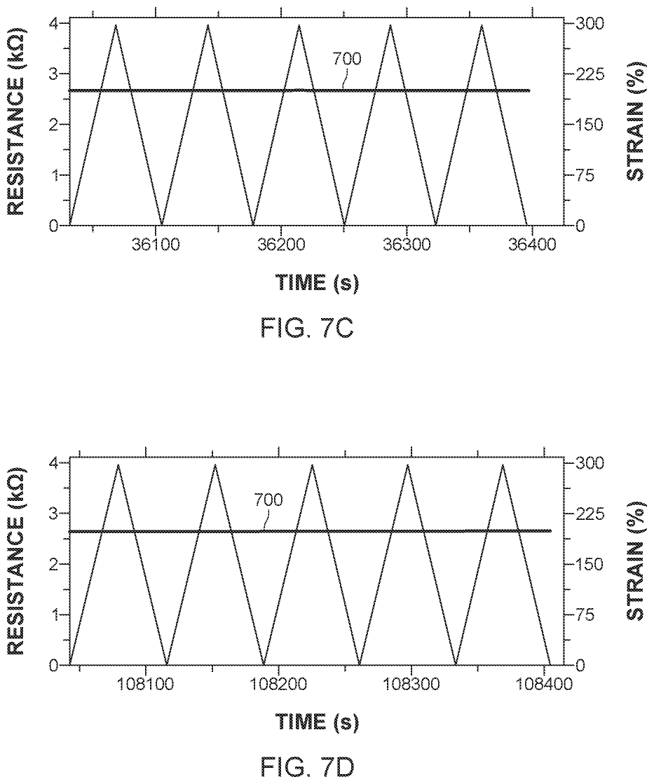

In this regard, FIG. 7A shows that the novel fibers 204 have both a good durability and reproducibility, which makes them viable for long-term applications. This figure shows that the novel fiber 204 with εₚ=700% was able to resist 1,766 stretching/relaxing cycles, corresponding to 120,000s, from 0 to 300% strain at 5 cm min⁻¹ before failure. During the 1,766 cycles, the resistance of the fiber was almost unchanged, as shown by curve 700 in FIGS. 7B to 7D, which represents the resistance profiles at cycles 1 to 5, 501 to 505 and 1501 to 1505, respectively.

Thus, a stretchable conductor based on the novel coaxial fiber 204 displays one or more of the following characteristics: (1) high conductivity, (2) high stretchability, (3) resistance stability over a wide range of strains, (4) good durability and reproducibility, (5) protection from short circuiting and safe operation (made possible by the electrical insulator outer TPE sheath), (6) easily scalable process, and (7) easy integration with wearable textiles.

As previously discussed, the PBP was used to modify both the electrical conductivity and the stretchability of the PEDOT/PSS material. The hydrophobic polyethylene segments and hydrophilic polyethylene glycol segments contained in PBP facilitated the interaction with hydrophobic PEDOT grains and hydrophilic PSS. At the same time, the poly (ethylene glycol) in the copolymer improved the electrical conductivity of the PEDOT/PSS material.

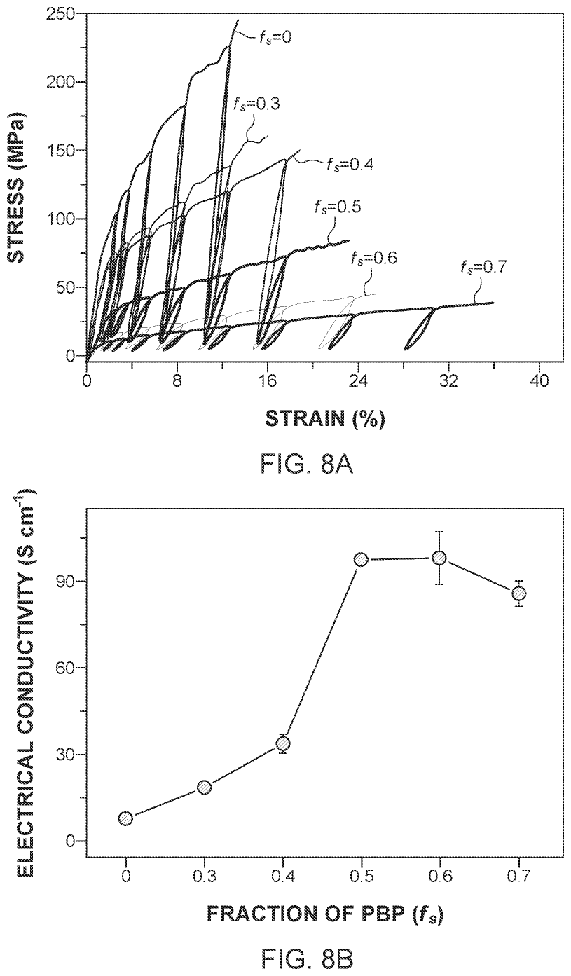

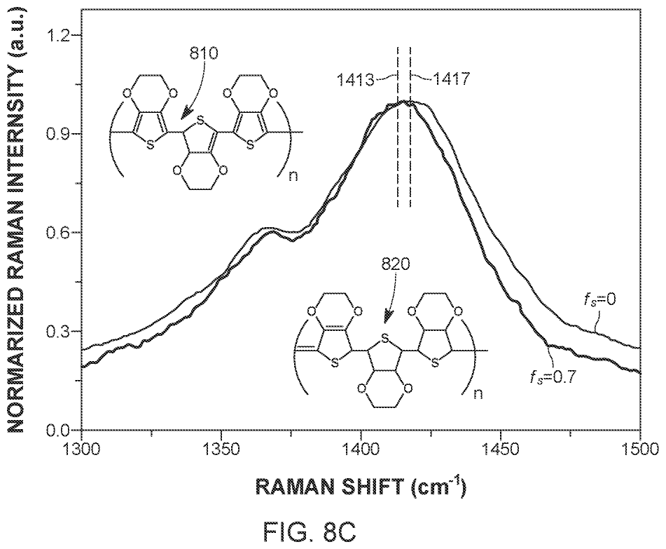

To investigate the mechanical properties of the PEDOT/PSS/PBP material, incremental cyclic loading/unloading tests were performed on PEDOT/PSS/PBP films with different PBP loadings. Note that a PBP weight fraction (fₛ=0.7) corresponds to the nominal configuration used by default, for all experiments discussed in this application. For investigating the effect of the PBP fraction on the overall fiber, different film samples with fₛ ranging from 0 to 0.7 were prepared. All films displayed a bilinear stress-strain curve, characteristic of a linear strain-hardening behavior, as shown in FIG. 8A. These results showed that the introduction of the PBP (fₛ=0.7) into the PEDOT/PSS solution resulted in a tensile strength of 34.1±4.0 MPa and a Young's modulus of 0.5±0.1 MPa, which are respectively 7 and 10 times lower than the pure PEDOT/PSS films. Additionally, the elongation before failure of the PEDOT/PSS/PBP film largely increased from 12.5±1.0% (for the pristine film) to 35.5±2.2% (when using fₛ=0.7). These results indicate that the addition of the PBP contributes to plasticizing the PEDOT/PSS material. This is important for being capable of stretching the PEDOT/PSS/PBP ribbons to very high levels, without breaking them. The addition of the PBP material also reduced the elastic properties that facilitate the buckling of the PEDOT/PSS/PBP ribbons during the unloading.

The electrical conductivity of the tested PEDOT/PSS film was found to be low (7.8 S cm⁻¹), consistent with other previously reported values. However, the electrical conductivity increased with the addition of the PBP material, reaching 95 S cm⁻¹ with fₛ=0.6 and slightly decreased to 88 S cm⁻¹ with fₛ=0.7, see FIG. 8B, suggesting that the PBP material can improve the overall electrical conductivity of PEDOT/PSS material.

To better understand the role of the PBP material, the microstructure of the samples with and without PBP were examined using Raman spectroscopy. FIG. 8C shows a strong peak at 1417 cm⁻¹ that can be attributed to the Cα-Cβ symmetric stretching of the thiophene ring in the PEDOT chains in pure PEDOT/PSS films. The shoulder peak at 1450 cm⁻¹ can be attributed to the breathing of the benzoid structure 810 of the thiophene ring, and presents a coil conformation structure associated with a low-conductive state. The addition of the PBP material (fₛ=0.7) produces a 4 cm⁻¹ red-shift of the Raman spectrum, from pure PEDOT/PSS films. The weakening of the shoulder signal at 1450 cm⁻¹ corresponds to a benzoid structure 810, which is consistent with a benzoid-to-quinoid structural transformation (the quinoid structure 820 is also shown in FIG. 8C). Thus, it is believed that the PBP material influences the electrical performance by achieving a linear or expanded-coil conformation that facilitates electron transfer, which participates in improving the final conductivity of the fiber.

According to these observations, a high loading of PBP (for example, a fraction fₛ between 0.5 and 0.6) in the PEDOT/PSS/PBP system appears beneficial on all aspects: it increases the conductivity of the core in the coaxial fibers; it increases its ductility, which allows it to be easily stretched; and it decreases its elastic modulus and, as a result, buckles at low-stress levels. In addition, it was found that a high amount of PBP leads to the replacement of a significant portion of the PEDOT/PSS material and therefore, it reduces the cost of the material, making it an economically viable alternative. By stretching the coaxial fibers, the cross-section of the conductive ribbon and the resistance of the fiber do not change, unless the buckled structure gets completely unfolded, which then results in a fully stretched fiber.

The performance of the coaxial fibers 204 as stretchable conductors was tested as follows. A 2 cm long fiber (εₚ=900%) was manufactured according to the method of FIG. 1 and used to make an electrical circuit in which the fiber acting as a stretchable wire for connecting a light-emitting diode (LED). The resistance of the fiber was low enough (2.7 kΩ) in order for the LED to be powered at a relatively low voltage (6 V). By stretching the fiber from a 0% to 520% strain, the brightness of the LED did not change notably.

In another application, the 2 cm long fiber (εₚ=900%) was used as a stretchable heater, with the heat generated by the Joule effect within PEDOT/PSS core, when loaded by an electrical current. Conducting-polymer-based heaters are classical and can create a temperature field nearby via radiation and convection. However, previous studies showed that PEDOT/PSS-based heaters were not stretchable, limiting their use for highly stretchable and wearable devices. In the current example, the 2 cm-long coaxial fiber was able to generate a temperature of 42° C., at 6 V, 0% strain (ambient temperature was 22° C. at 0 V, 0% strain). The temperature distribution remained at 42° C. on most of the fiber surface when the fiber was stretched to 100% and 200% strains. When stretching the fiber to 300% or 400% strain, the temperature distribution decreased to 35° C., with a small portion of the fiber's surface reaching 42° C.

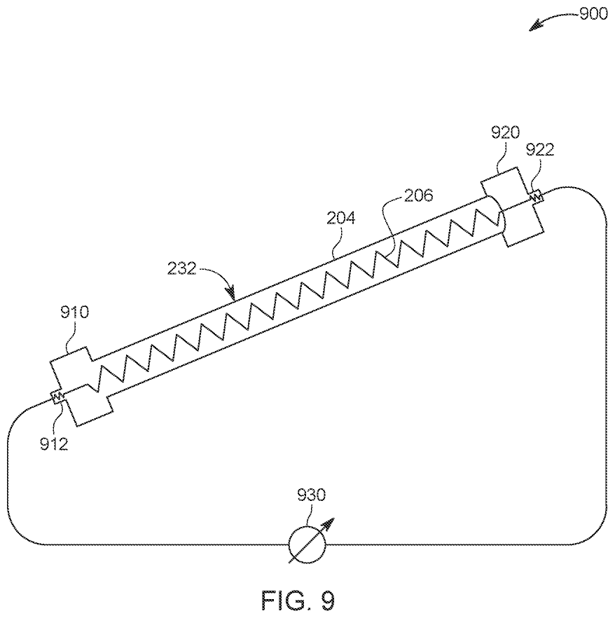

The above discussed embodiments disclose a highly-stretchable coaxial fiber 204 with a buckled ribbon structure 206 that can be reversibly stretched up to 680% of its original length, with less than 4% change in its resistance. The buckled ribbon 206 in the fiber 204 was created through a combination of coaxial wet-spinning, solution stretching and self-buckling processes. The maximum failure strain of the conductive fiber 204 can be manipulated by varying the pre-strain applied to the fiber during the pre-stretching process. These coaxial fiber conductors can be incorporated into numerous applications including electrical wires, wearable heaters requiring stretchability, and stable electrical resistance. In this regard, FIG. 9 illustrates such a fiber 204 that was provided with end caps 910 and 920. Each of the cap 910 and 920 has an external electrical contact 912 and 922, which may be a pin. Each pin is directly attached to the ribbon 206 so that an electrical current can flow between the contact 912 and the contact 922. More of such fibers 204 may be bundled together to form a wire 900 with a desired number of electrical contacts at each end. The caps 910 and 920 may be attached to the sheath 232 by known methods, for example, heating or gluing, while the electrical contacts 912 and 922 may be made to electrically connect the ribbon 206 if they are shaped as a needle, which is then inserted inside the sheath 232. Other methods for attaching the caps and contacting the ribbon may be used. In one application, the electrical contacts 912 and 922 may be attached to a power source 930, which is configured to generate an electrical current through the fiber 204. In this way, Joule heat is generated in the ribbon 206, so that the entire fiber 204 acts as a heater. Those skilled in the art would understand that the fiber 204 can also be used to transmit data or commands for various electronic applications.

The novel fiber 204 has one or more advantages when compared to other technologies that are based on liquid metal injected elastomer tubes or hierarchically buckled CNT films on elastomer fibers because (1) for this novel fiber environmentally friendly materials were used; (2) the fiber has the potential of large scale production by continuous wet-spinning and drawing process; and (3) the fiber can be easily and safely integrated with wearable textiles. If the inner conductive material or properties of the coaxial fiber are engineered to meet the needs of high-conductivity applications, they could be used as conductive cables for robotics, interconnects for highly elastic electronic circuits or candidates to replace some of the unstretchable commercial metallic wires.

The disclosed embodiments provide highly-stretchable, coaxial fiber conductors that are manufactured to have self-buckling conductive polymer ribbons inside a thermoplastic elastomer tube, using a “solution stretching-drying-buckling” process. The unique hierarchically-buckled and conductive core in the axial direction makes the resistance of the fiber very stable, with less than 4% change when applying as much as 680% strain. These fibers can then be directly used as stretchable electrical interconnects or wearable heaters. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

[1] Ma, R.; Kang, B.; Cho, S.; Choi, M.; Baik, S. Extraordinarily High Conductivity of Stretch-able Fibers of Polyurethane and Silver Nanoflowers. Acs Nano 2015, 9, 10876-10886.
[2] Zhou, J.; Xu, X.; Xin, Y.; Lubineau, G. Coaxial thermoplastic elastomer-wrapped carbon nanotube fibers for deformable and wearable strain sensors. Adv. Funct. Mater. 2018, 26, 1705591.

1. A stretchable electrically conductive coaxial fiber comprising:
a tubular sheath that is made from a thermoplastic elastomer that is an electrical insulator; and
an electrically conductive strip located inside the tubular sheath, wherein the conductive strip is buckled inside the tubular sheath to form a ribbon.

2. The coaxial fiber of claim 1, wherein the tubular sheath includes a single conductive strip.

3. The coaxial fiber of claim 1, wherein neither the tubular sheath nor the conductive strip includes carbon fibers.

4. The coaxial fiber of claim 1, wherein neither the tubular sheath nor the conductive strip includes carbon nanofibers.

5. The coaxial fiber of claim 1, wherein a buckle density of the conductive strip inside the tubular sheath is larger than 2 mm⁻¹.

6. The coaxial fiber of claim 1, wherein the tubular sheath fully encapsulates the conductive strip.

7. The coaxial fiber of claim 1, wherein the thermoplastic elastomer is polystyrene-block-polyisoprene-block-polystyrene.

8. The coaxial fiber of claim 7, wherein the conductive strip is made of a blend of conductive polymers and polyethylene-block-poly-(ethylene glycol).

9. The coaxial fiber of claim 7, wherein the conductive polymer is made of a mixture of poly (3,4-ethylene-dioxythiophene) and polystyrene sulfonate.

10. The coaxial fiber of claim 1, wherein the conductive strip is buckled inside the tubular sheath so that after applying a strain of over 600% to the tubular sheath, along a longitudinal axis of the fiber, a change in an electrical resistance of the conductive strip is less than 4%.

11. A method for making a stretchable electrically conductive coaxial fiber, the method comprising:
providing a conductive dispersion solution;
providing a thermoplastic elastomer solution;
wet-spinning the conductive dispersion solution and the thermoplastic elastomer solution to form a precursor coaxial fiber, which has a core including the conductive dispersion solution in a fluid state and has a tubular sheath including the thermoplastic elastomer solution in a solid state;
bathing the precursor fiber into a bath to further solidify the tubular sheath while the core remains into the liquid phase;
straining the precursor fiber with a given strain;
drying the precursor fiber to solidify the core to form an electrically conductive strip; and
removing the given strain so that the electrically conductive strip buckles inside the tubular sheath to form a ribbon.

12. The method of claim 11, wherein the thermoplastic elastomer is polystyrene-block-polyisoprene-block-polystyrene dissolved in dichloromethane.

13. The method of claim 12, wherein the bath includes at least one of ethanol, acetone, isopropyl alcohol, a mixture of ethanol and acetone with a volume ratio of 1:1, a mixture of acetone and isopropyl alcohol with a volume ratio of 1:1, a mixture of ethanol and isopropyl alcohol with a volume ratio of 1:1, and is configured to evaporate the dichloromethane.

14. The method of claim 12, wherein the conductive dispersion solution is made of a blend of conductive polymers and a copolymer.

15. The method of claim 12, wherein the conductive dispersion solution is made of a mixture of poly (3,4-ethylene-dioxythiophene) and polystyrene sulfonate and further includes polyethylene-block-poly-(ethylene glycol).

16. The method of claim 12, wherein a buckle density of the conductive strip inside the tubular sheath is at least 2 mm⁻¹.

17. The method of claim 12, wherein the tubular sheath fully encapsulates the conductive strip.

18. The method of claim 12, wherein the conductive strip is buckled inside the tubular sheath so that after applying a strain of over 600% to the tubular sheath, along a longitudinal axis of the fiber, a change in an electrical resistance of the conductive strip is less than 4%.

19. A flexible electrical cable comprising:
a stretchable electrically conductive coaxial fiber; and
first and second end caps attached to ends of the coaxial fiber and the first and second end caps are configured as electrical pads,
wherein the coaxial fiber includes:
a tubular sheath that is made from a thermoplastic elastomer that is an electrical insulator, and
an electrically conductive strip located inside the tubular sheath,
wherein the conductive strip is buckled inside the tubular sheath to form a ribbon.

20. The flexible electrical cable of claim 19, wherein the tubular sheath includes a single conductive strip and wherein neither the tubular sheath nor the conductive strip includes carbon fibers.
